(19) United States
(12) Patent Application Publication
(10) Pub. No.: US 2008/0154555 A1
(43) Pub. Date: Jun. 26, 2008

(54) Method and apparatus to disambiguate state information for multiple items tracking

(75) Inventors: Wei Qu, Chicago, IL (US); Dan Schonfeld, Glenview, IL (US); Magdi A. Mohamed, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: MOTOROLA, INC., Schaumburg, IL (US)

(21) Appl. No.: 11/549,542

(22) Filed: Oct. 13, 2006

(51) Int. Cl. G06F 17/10

(52) U.S. Cl. 703/2

(57) ABSTRACT

Automatic use (102) of a disjoint probabilistic analysis of captured temporally parsed data (101) regarding at least a first and a second item serves to facilitate disambiguating state information as pertains to the first item from information as pertains to the second item. This can also comprise, for example, using a joint probability as pertains to the temporally parsed data for the first item and the temporally parsed data for the second item, by using, for example, a Bayesian-based probabilistic analysis of the temporally parsed data.

### TECHNICAL FIELD

This invention relates generally to the tracking of multiple items.

### BACKGROUND

The tracking of multiple objects (such as, but not limited to, objects in a video sequence) is known in the art. Considerable interest exists in this regard as successful results find application in various use case settings, including but not limited to target identification, surveillance, video coding, and communications. The tracking of multiple objects becomes particularly challenging when objects that are similar in appearance draw close to one another or present partial or complete occlusions. In such cases, modeling the interaction amongst objects and solving the corresponding data association problem comprises a significant problem.

A widely adopted solution to address this need uses a centralized solution that introduces a joint state space representation that concatenates all of the object's states together to form a large resultant meta state. This approach provides for inferring the joint data association by characterization of all possible associations between objects and observations using any of a variety of known techniques. Though successful for many purposes, unfortunately such approaches are neither a comprehensive solution nor always a desirable approach in and of themselves.

As one example in this regard, these approaches tend to handle an error merge problem at tremendous computational cost due to the complexity inherent to the high dimensionality of the joint state representation. In general, this complexity tends to grow exponentially with respect to the number of objects being tracked. As a result, in many real world applications these approaches are simply impractical for real-time purposes.

### BRIEF DESCRIPTION OF THE DRAWINGS

The above needs are at least partially met through provision of the method and apparatus to facilitate disambiguating state information for multiple items described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a model as configured in accordance with various embodiments of the invention;

FIG. 4 comprises a model as configured in accordance with various embodiments of the invention;

FIG. 5 comprises a model as configured in accordance with various embodiments of the invention; and

FIG. 6 comprises a model as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, automatic use of a disjoint probabilistic analysis of captured temporally parsed data regarding at least a first and a second item serves to facilitate disambiguating state information as pertains to the first item from information as pertains to the second item. This can also comprise, for example, using a joint probability as pertains to the temporally parsed data for the first item and the temporally parsed data for the second item, by using, for example, a Bayesian-based probabilistic analysis of the temporally parsed data.

The latter can comprise using, if desired, a transitional probability as pertains to temporally parsed data for the first item as was captured at a first time and temporally parsed data for the first item as was captured at a second time that is different than the first time (by using, for example, a transitional probability as pertains to first state information for the first item as pertains to the first time and second state information for the first item as pertains to the second time) as well as using a transitional probability as pertains to temporally parsed data for the second item as was captured at the first time and temporally parsed data for the second item as was captured at the second time (by using, for example, a transitional probability as pertains to first state information for the second item as pertains to the first time and second state information for the second item as pertains to the second time).

This approach can further comprise, if desired, using a conditional probability as pertains to temporally parsed data for the first item and state information for the first item as well as a conditional probability as pertains to temporally parsed data for the second item and state information for the second item.

In effect, these teachings related to providing multiple interactive trackers in a manner that extends beyond a traditional use of Bayesian tracking in a tracking structure. In particular, this approach avoids using a joint state representation that introduces high complexity and that requires corresponding high computational costs. By these teachings, as objects exhibit interaction, such interaction can be modeled in terms of potential functions. By one approach, this can comprise modeling the interactive likelihood densities by a so-called gravitation attraction versus a so-called magnetic repulsion scheme. In addition, if desired, one can approximate 2^{nd} order state transition density by an ad hoc 1^{st} order inertia Markov chain in a unified particle filtering implementation. The proposed models represent the cumulative effect of virtual physical forces that objects undergo while interacting with one another. Those skilled in the art will recognize and appreciate that these approaches implicitly handle the error merge problems of the prior art and further serve to minimize corresponding object labeling problems.

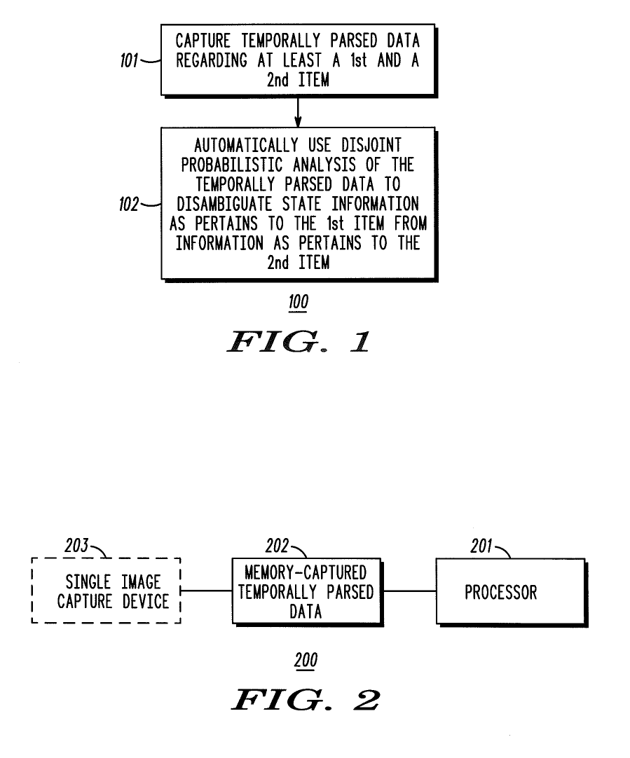

These and other benefits may become clearer upon making a thorough review and study of the following detailed description. Referring now to the drawings, and in particular to FIG. 1, a general overall view of these teachings suggests a process 100 that provides for capturing 101 temporally parsed data regarding at least a first and a second item. These items could comprise any of a wide variety of objects including but not limited to discernable energy waves such as discrete sounds, continuous or discontinuous sound streams from multiple sources, radar images, and so forth. In many application settings, however, these items will comprise physical objects or, perhaps more precisely, images of physical objects.

This step of capturing temporally parsed data can therefore comprise, for example, providing a video stream as provided by a single data capture device of a particular scene (such as a scene of a sidewalk, an airport security line, and so forth) where various of the frames contain data (that is, images of objects) that represent samples captured at different times. Although, as noted, such data can comprise a wide variety of different kinds of objects, for the sake of simplicity and clarity the remainder of this description shall presume that the objects are images of physical objects unless stated otherwise. Those skilled in the art will recognize and understand that this convention is undertaken for the sake of illustration and is not intended as any suggestion of limitation with respect to the scope of these teachings.

This process 100 then provides for automatically using 102, at least in part, disjoint probabilistic analysis of the temporally parsed data to disambiguate state information as pertains to a first such item from information (such as, but not limited to, state information) as pertains to a second such item. Those skilled in the art will understand that this process 100 does not require use of a disjoint probabilistic analysis in this regard under all operating circumstances; in many cases such an approach will only be automatically occasioned when such items approach near (and/or impinge upon) one another. In cases where such items are further apart from one another, if desired, alternative approaches can be employed.

Generally speaking, by one approach, this probabilistic analysis can comprise using, at least in part, a Bayesian-based probabilistic analysis of the temporally parsed data. This can comprise, at least in part, using a joint probability as pertains to the temporally parsed data for the first item and the temporally parsed data for the second item. More detailed examples will be provided below in this regard.

This step can further comprise, if desired, using transitional probabilities as pertain to these items. For example, this step will accommodate using a first transitional probability as pertains to temporally parsed data (such as, but not limited to, first state information) for the first item as was captured at a first time and temporally parsed data (such as, but not limited to, second state information) for this same first item as was captured at a second time that is different than the first time. In a similar fashion, this step will accommodate using another transitional probability as pertains to temporally parsed data (such as, but not limited to, first state information) for the second item as was captured at the first time and temporally parsed data (such as, but not limited to, second state information) for this same second item as was captured at that second time.

This step will also further accommodate, if desired, effecting the aforementioned Bayesian-based probabilistic analysis of the temporally parsed data by using conditional probabilities. In particular, for example, this can comprise using a first conditional probability as pertains to temporally parsed data and state information for the first item and a second conditional probability as pertains to temporally parsed data and state information for the second item. Again, more details regarding such approaches are provided below.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform 200 will now be provided.

In this illustrative example, a processor 201 operably couples to a memory 202. The memory 202 serves to store the aforementioned captured temporally parsed data regarding at least a first and a second item. By one approach, this memory 202 can be operably coupled to a single image capture device 203 such as, but not limited to, a video camera that provides sequential frames of captured video content of a particular field of view.

The processor 201 is configured and arranged to effect the above-described automatic usage of a disjoint probabilistic analysis of the temporally parsed data to facilitate disambiguation of state information as pertains to the first item from information (such as, but not limited to, state information) as pertains to the second item. This can comprise some or all of the above-mentioned approaches in this regard as well as the more particular examples provided below. By one approach, this processor 201 can comprise a partially or wholly programmable platform as are known in the art. Accordingly, such a configuration can be readily achieved via programming of the processor 201 as will be well understood by those skilled in the art.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

A more detailed presentation of a particular approach to effecting such distributed multi-object tracking by use of multiple interactive trackers will now be provided. Again, those skilled in the art will understand and appreciate that this more-detailed description is provided for the purpose of illustration and not by way of limitation with respect to the scope or reach of these teachings.

The described process uses a four dimension parametric ellipse to model visual object's boundaries. The state of an individual object is denoted here by xₜⁱ=(cxₜⁱ, cyₜⁱ, aₜⁱ, pₜⁱ) where I=1, . . . , M is the index of objects, t is the time index, (cx cy) is the center of the ellipse, a is the major axis, and p is the orientation in radians. Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. The ratio of the major and minor axis of the ellipse is kept constantly equal to its value as computed during initialization in this example. This approach also denotes the image observation of xₜⁱ by zₜⁱ, the set of all states up to time t by x_{0:t}ⁱ where x₀ⁱ is a prior initialization, and the set of all observations up to time t by z_{1:t}ⁱ. This approach also denotes the interactive observations of zₜⁱ at time t by zₜ^{J}^{ₜ} where Jₜ={jl₁, jl₂, . . . }. The elements jl₁, jl₂, . . . ε {1, . . . , M}, jl₁, jl₂, . . . ≠I are the indexes of objects whose observations interact with zₜⁱ. Similarly, z_{1:t}^{J}^{_{1:t}} represents the collection of the interactive observation sets up to time t.

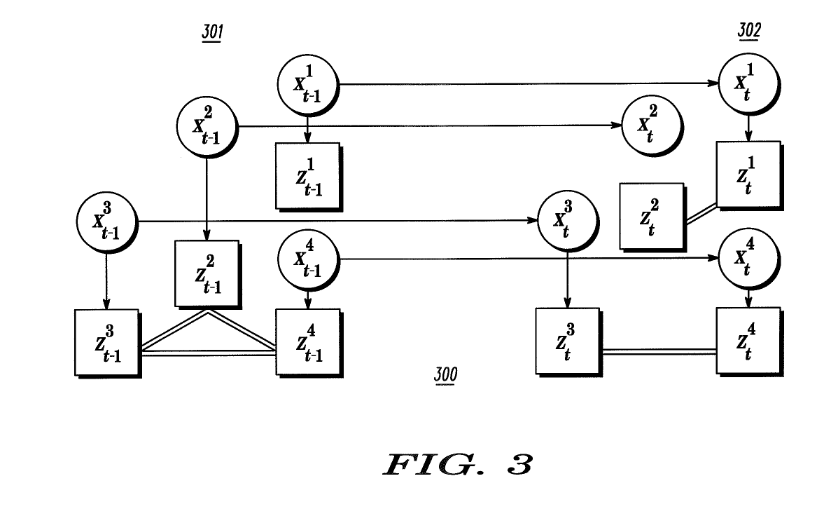

Since the interactive relationship among observations is likely changing, J may also differ over time. For example, in the graphical model 300 shown in FIG. 3, the interactive observation set for zₜ₋₁² at time t-1 is zₜ₋₁^{J}^{ₜ₋₁}={zₜ₋₁³, zₜ₋₁⁴}. At time t, however zₜ^{J}^{ₜ}={zₜ¹}.

When multiple visual objects move close to one another or other present partial or complete occlusions, it can be generally difficult for the trackers to segment and distinguish these spatially adjacent objects from image observations as the interactive observations are not independent (note that p(zₜ¹, . . . , zₜ^{M})≠Πᵢ₌₁^{M}p(zₜⁱ)). As a result, one cannot reliably simply factorize the posteriors of different objects. This conditional dependency of objects comprises, in the view of the inventors, a significant reason why multiple independent trackers have difficulty coping with the aforementioned error merge problem as well as the object labeling problem.

By one approach, the present teachings espouse using a separate tracker for each object. In such a case, an error merge problem can occur in at least two cases. First, when two visual objects move closer or begin to present occlusion, the object with the strong observation (in the sense of a large visual image) effectively pulls the tracker of the object with the weaker observation. Second, after occlusion, when two objects move apart, their associated optical trackers often cannot detach and remain bonded while simultaneously tracking the object with the stronger observation.

In these scenarios, it may be helpful to image the influence of an invisible force among the interactive trackers that attracts them to merge together when objects move closer and that prevents them from disjointing when these objects move apart. With this in mind, by analogy, one may then imagine these effects to be associated with an associated tracker's “mass.” When objects are far apart, the corresponding gravitational force between their trackers is relatively weak and can be effectively ignored. Similarly, when such objects are adjacent or occluded, this attractive force becomes relatively strong. This imaginary construct permits an interesting application of Newton's Laws.

By Newton's Third Law, the relative forces between two such trackers will remain equal. At the same time, however, Newton's Second Law would hold that trackers corresponding to different masses will have corresponding different accelerations. As a result, after several frames of captured data, the tracker having a smaller mass (which will correlate to a larger acceleration) will be attracted to merge with the object having the larger mass (i.e., the larger observation which correlates to a small acceleration) and thus error merge will likely occur. To resist the excessive attraction that is viewed as occurring, in this analogical example, a repulsive force can be introduced between these interacting trackers.

In particular, when objects move closer, a repulsive force can be introduced and used to prevent the trackers from falsely merging. As the objects move away, this repulsive force can also help the trackers to detach from one another. As will be demonstrated below, another analogy can be introduced to facilitate the introduction of such a repulsive force; magnetic field theory.

Referring again to FIG. 3, the illustrated dynamic graphical model 300 is shown as depicting two consecutive frames 301 and 302 for multiple objects with interactive observations. Two layers are shown. A so-called hidden layer is noted with circle nodes that represent the states of objects xⁱ. A counter part so-called observable layer represents the observations zⁱ that are associated with the hidden states. A directed link between consecutive states associated with a same object represents the state transition density which comprises a Markov chain. Here, however, the illustrated example release the usual 1^{st} order Markov chain assumption in regular Bayesian tracking approaches and allows instead higher order Markov chains for generality.

The directed link from object xⁱ to its observation zⁱ represents a generative relationship and can be characterized by the local observation likelihood p(zⁱ|xⁱ). The undirected link between observation nodes represents the interaction itself. The structure of the observation layer at each time depends on the spatial relationships among observations for the objects. That is, when observations for two or more visual objects are sufficiently close or leading to occlusion, an undirected link between them is constructed to represent that dependency event.

Those skilled in the art will note that the graphical model 300 illustrated in FIG. 3 can lead to complicated analysis. Therefore, if desired, this graphical model for M objects can be further decomposed into M submodels using three rules. Rule 1—each submodel focuses on only one object. Rule 2—only the interactive observations that have direct links to the analyzed object's observation are kept with noninteractive observations and all other objects' state nodes being removed. And Rule 3—each undirected link between two interactive observations is decomposed into two different directed links (with the direction corresponding to the other object's observation to the analyzed object's observation.

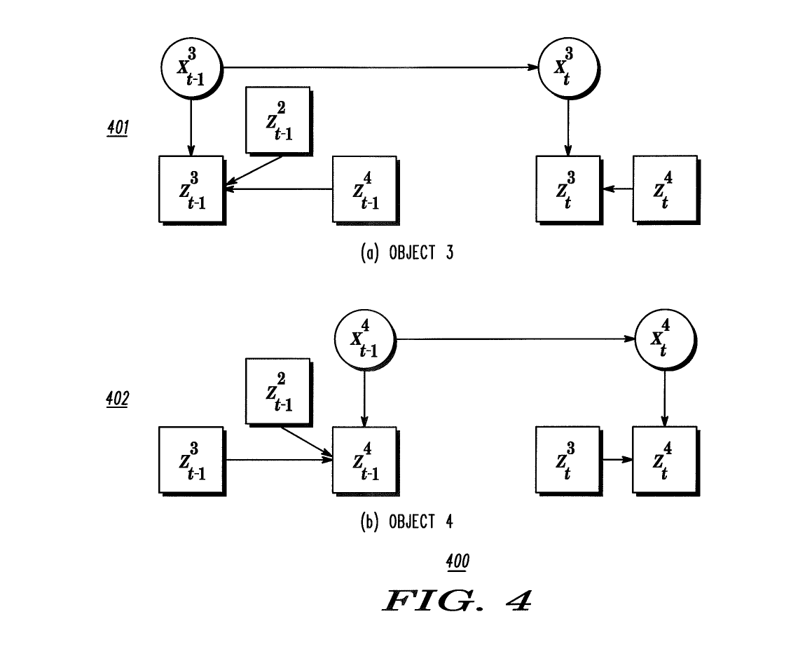

FIG. 4 illustrates an exemplary part of such decomposition rules as applied to the model shown in FIG. 3 for object 3 401 and object 4 402. Those skilled in the art will note that such an approach neglects the temporal state correlation of certain interactive observations zⁱ when considering object i, but such information in fact is taken into account when considering object j. Therefore, when running all of the trackers simultaneously, the decomposed submodels together are able to retain all the information (regarding nodes and links) from the original model. For many purposes this can comprise a powerful and useful simplification.

By one approach these decomposed graphs all comprise directed acyclic independence graphs as are known in the art. By then applying the separation theorem to the associated moral graphs (where again both such notions are well known in the art) one then obtains the corresponding Markov properties (namely, the conditional independence of the decomposed graphs.

To model the density propagation for each object, one may then estimate the posterior based on all of the involved observations p(x_{0:t}ⁱ|z_{1:t}ⁱ, z_{1:t}^{J}^{_{1:t}}). In such a case, the resultant formulation will be seen and understood to be consistent with a typical Bayesian tracker.

The density propagation for each interactive tracker can be formulated as:

$$\begin{matrix}p ( {x}_{0 : t}^{i} \vert {z}_{1 : t}^{i} , {z}_{1 : t}^{{J}_{1 : t}} ) = \frac{p ( {z}_{t}^{i} \vert {x}_{0 : t}^{i} , {z}_{1 : t - 1}^{i} , {z}_{1 : t}^{{J}_{1 : t}} ) p ( {x}_{0 : t}^{i} , {z}_{1 : t - 1}^{i} , {z}_{1 : t}^{{J}_{1 : t}} )}{p ( {z}_{1 : t}^{i} , {z}_{1 : t}^{{J}_{1 : t}} )} \\ = \frac{p ( {z}_{t}^{i} \vert {x}_{0 : t}^{i} , {z}_{1 : t - 1}^{i} , {z}_{1 : t}^{{J}_{1 : t}} ) p ( {x}_{0 : t}^{i} \vert {z}_{1 : t - 1}^{i} , {z}_{1 : t}^{{J}_{1 : t}} )}{p ( {z}_{t}^{i} \vert {z}_{1 : t - 1}^{i} , {z}_{1 : t}^{{J}_{1 : t}} )} \\ = \frac{p ( {z}_{t}^{i} \vert {x}_{t}^{i} , {z}_{t}^{{J}_{t}} ) p ( {x}_{0 : t}^{i} , {z}_{1 : t - 1}^{i} , {z}_{1 : t}^{{J}_{1 : t}} )}{p ( {z}_{t}^{i} \vert {z}_{1 : t - 1}^{i} , {z}_{1 : t}^{{J}_{1 : t}} )}\end{matrix} \qquad ( 1 )$$

Equation 1 uses the conditional independence property p(zₜⁱ|x_{0:t}ⁱ, z_{1:t-1}ⁱ, z_{1:t}^{J}^{_{1:t}})=p(zₜⁱ|xₜⁱ, zₜ^{J}^{ₜ}). Here, p(zₜⁱ|xₜⁱ, zₜ^{J}^{ₜ}) represents the interactive likelihood while p(x_{0:t}ⁱ|z_{1:t-1}ⁱ, z_{1:t}^{J}^{_{1:t}}) represents the interactive prior density. These two densities can be further developed as follows.

The interactive likelihood can be expressed as shown in equation 2:

$$p \text{(} {z}_{t}^{i} \vert {x}_{t}^{i} , {z}_{t}^{{J}_{t}} ) = p \text{(} {z}_{t}^{i} \vert {x}_{t}^{i} ) \frac{p ( {z}_{t}^{i} \vert {x}_{t}^{i} , {z}_{t}^{{J}_{t}} )}{p \text{(} {z}_{t}^{{J}_{t}} \vert {x}_{t}^{i} )} . \qquad ( 2 )$$

The local likelihood p(zₜⁱ|zₜⁱ) characterizes the so-called gravitational force between interactive observations.

The interactive prior density of x_{0:t}ⁱ can be expressed as shown below in equations 3 and 4:

$$\begin{matrix}p ( {x}_{0 : t}^{i} \vert {z}_{1 : t - 1}^{i} , {z}_{1 : t}^{{J}_{1 : t}} ) = \frac{p ( {x}_{t}^{i} , {z}_{t}^{{J}_{t}} \vert {x}_{0 : t - 1}^{i} , {z}_{1 : t - 1}^{i} , {z}_{1 : t - 1}^{{J}_{t - 1}} )}{p ( {z}_{t}^{{J}_{t}} \vert {z}_{1 : t - 1}^{i} , {z}_{1 : t - 1}^{{J}_{t - 1}} )} \\ p ( {x}_{0 : t - 1}^{i} \vert {z}_{1 : t - 1}^{i} , {z}_{1 : t - 1}^{{J}_{t - 1}} ) \\ = \frac{p ( {x}_{t}^{i} , {z}_{t}^{{J}_{t}} \vert {x}_{0 : t - 1}^{i} )}{p ( {z}_{t}^{{J}_{t}} \vert {z}_{1 : t - 1}^{i} , {z}_{1 : t - 1}^{{J}_{t - 1}} )} p ( {x}_{0 : t - 1}^{i} \vert {z}_{1 : t - 1}^{i} , {z}_{1 : t - 1}^{{J}_{t - 1}} ) \\ = \frac{p ( {z}_{t}^{{J}_{t}} \vert {x}_{t}^{i} , {x}_{0 : t - 1}^{i} )}{p ( {z}_{t}^{{J}_{t}} \vert {z}_{1 : t - 1}^{i} , {z}_{1 : t - 1}^{{J}_{t - 1}} )} p ( {x}_{t}^{i} \vert {x}_{0 : t - 1}^{i} ) p ( {x}_{0 : t - 1}^{i} \vert {z}_{1 : t - 1}^{i} , {z}_{1 : t - 1}^{{J}_{t - 1}} ) \\ = \frac{p ( {z}_{t}^{{J}_{t}} \vert {x}_{t}^{i} )}{p ( {z}_{t}^{{J}_{t}} \vert {z}_{1 : t - 1}^{i} , {z}_{1 : t - 1}^{{J}_{t - 1}} )} p ( {x}_{t}^{i} \vert {x}_{0 : t - 1}^{i} ) p ( {x}_{0 : t - 1}^{i} \vert {z}_{1 : t - 1}^{i} , {z}_{1 : t - 1}^{{J}_{t - 1}} ) .\end{matrix} \qquad \begin{matrix}\begin{matrix}\begin{matrix}\begin{matrix}\begin{matrix}\begin{matrix}\begin{matrix}\begin{matrix}\begin{matrix}\begin{matrix}( 3 ) \\ \end{matrix} \\ \end{matrix} \\ \end{matrix} \\ \end{matrix} \\ \end{matrix} \\ \end{matrix} \\ \end{matrix} \\ \end{matrix} \\ ( 4 )\end{matrix} \\ \end{matrix}$$

In equation 3 the conditional independence property p(xₜⁱ, zₜ^{J}^{ₜ}|x_{0:t-1}ⁱ, z_{1:t-1}^{J}^{_{1:t-1}})=p(xₜⁱ, zₜ^{J}^{ₜ}|x_{0:t-1}ⁱ) has been used. Equation 4 uses the property that p(zₜ^{J}^{ₜ}|xₜⁱ, x_{0:t-1}ⁱ)=p(zₜ^{J}^{ₜ}|xₜⁱ).

By substituting equations 2 and 4 back into equation 1 and then rearranging the order, one obtains:

$$\begin{matrix}p ( {x}_{0 : t}^{i} \vert {z}_{1 : t}^{i} , {z}_{1 : t}^{{J}_{t - 1}} ) = p ( {z}_{t}^{i} \vert {x}_{t}^{i} ) p ( {x}_{t}^{i} \vert {x}_{0 : t - 1}^{i} ) p ( {x}_{0 : t - 1}^{i} \vert {z}_{1 : t - 1}^{i} , {z}_{1 : t - 1}^{{J}_{t - 1}} ) p ( {z}_{t}^{{J}_{t}} \vert {x}_{t}^{i} , {z}_{t}^{i} ) \\ \cdot \frac{1}{p ( {z}_{t}^{i} \vert {z}_{1 : t - 1}^{i} , {z}_{1 : t}^{{J}_{t - 1}} ) p ( {z}_{t}^{{J}_{t}} \vert {z}_{1 : t - 1}^{i} , {z}_{1 : t - 1}^{{J}_{t - 1}} )} \\ = {k}_{t} p ( {z}_{t}^{i} \vert {x}_{t}^{i} ) p ( {x}_{t}^{i} \vert {x}_{0 : t - 1}^{i} ) p ( {x}_{0 : t - 1}^{i} \vert {z}_{1 : t - 1}^{i} , {z}_{1 : t - 1}^{{J}_{t - 1}} ) \\ \cdot p ( {z}_{t}^{i} \vert {x}_{t}^{i} , {z}_{t}^{i} ) .\end{matrix} \qquad \begin{matrix}\begin{matrix}\begin{matrix}\begin{matrix} \\ ( 5 )\end{matrix} \\ \end{matrix} \\ \end{matrix} \\ ( 6 )\end{matrix}$$

The densities in the denominator of equation 5 are unrelated with xⁱ and thus the fraction in the second line of equation 5 becomes a normalization constant k^{t}. In equation 6, p(zₜⁱ|xₜⁱ) is the local likelihood, and p(xₜⁱ|x_{0:t-1}ⁱ) is the state transition density. By the present teachings one introduces a new density p(zₜ^{J}|xₜⁱ, zₜⁱ) referred to here as an interactive function to characterize the interaction among object's observations. When not activating the interaction among object's observations, this formulation will degrade to multiple independent particle filters. This can easily be achieved by switching p(zₜ^{J}|xₜⁱ, zₜⁱ) to a uniform distribution.

To estimate the posterior derived in the preceding, different density estimation methods (such as the Gaussian Mixture model, Kernel density estimation, and so forth) can be applied to the described. By one approach a sequential importance sampling method as is known in the art can provide a useful paradigm. {x_{0:t}^{i,n}, wₜ^{i,n}}ₙ₌₁^{N}^{ₛ} can denote a random measure that characterizes the posterior density p(x_{0:t}ⁱ|z_{1:t}ⁱ, z_{1:t}^{J}^{_{1:t}}), where {x_{0:t}^{i,n}, n,=1, . . . , Nₛ} is a set of support particles with associated weights {wₜ^{i,n}, n,=1, . . . , Nₛ}. In this example the weights are normalized so that Σₙwₜ^{i,n}=1. Therefore, the posterior density at t can be approximated as shown in equation 7:

$$p ( {x}_{0 : t}^{i} \vert {z}_{1 : t}^{i} , {z}_{1 : t}^{{J}_{1 : t}} ) \approx {\sum }_{n = 1}^{{N}_{s}} {w}_{t}^{i , n} δ ( {x}_{0 : t}^{i} - {x}_{0 : t}^{i , n} ) \qquad ( 7 )$$

where δ (.) is the Dirac delta function.

This results in a discrete weighted approximation to the true posterior density p(x_{0:t}ⁱ|z_{1:t}ⁱ, z_{1:t}^{J}^{_{1:t}}). The weights can be chosen according to known importance sampling theory. When the particles x_{0:t}^{i,n} are drawn from an importance density q(x_{0:t}ⁱ|z_{1:t}ⁱ, z_{1:t}^{J}^{_{1:t}}), then the corresponding weights in equation 7 can be represented as shown in equation 8:

$${w}_{t}^{i , n} \times \frac{p ( {x}_{0 : t}^{i , n} \vert {z}_{1 : t}^{i} , {z}_{1 : t}^{{J}_{1 : t}} )}{q ( {x}_{0 : t}^{i , n} \vert {z}_{1 : t}^{i} , {z}_{1 : t}^{{J}_{1 : t}} )} \qquad ( 8 )$$

In the sequential case, one could have particles constituting an approximation to p(x_{0:t-1}^{i,n}|z_{1:t-1}ⁱ, z_{1:t-1}^{J}^{_{1:t-1}}) and then need to approximate p(x_{0:t}^{i,n}|z_{1:t}ⁱ, z_{1:t}^{J}^{_{1:t}}), with a new set of particles at each iteration. When the importance density is chosen to factorize as shown in equation 9:

$$q ( {x}_{0 \text{:} t}^{i , n} \vert {z}_{1 \text{:} t}^{i} , {z}_{1 \text{:} t}^{{J}_{1 \text{:} t}} ) = q ( {x}_{t}^{i , n} \vert {x}_{0 : t - 1}^{i , n} , {z}_{1 : t}^{i} , {z}_{1 \text{:} t}^{{J}_{1 \text{:} t}} ) q ( {x}_{0 \text{:} t - 1}^{i , n} \vert {z}_{1 \text{:} t - 1}^{i} , {z}_{1 \text{:} t - 1}^{{J}_{1 \text{:} t - 1}} ) . \qquad ( 9 )$$

One can then obtain particles x_{0:t}^{i,n}˜q(x_{0:t}^{i,n}|z_{1:t}ⁱ, z_{1:t}^{J}^{_{1:t}}) by augmenting each of the exiting particles x_{0:t-1}^{i,n}˜q(x_{0:t-1}^{i,n}|z_{1:t-1}ⁱ, z_{1:t-1}^{J}^{_{1:t-1}}) with the new state xₜ^{i,n}˜q(xₜ^{i,n}|x_{0:t-1}^{i,n}, z_{1:t}ⁱ, z_{1:t}^{J}^{_{1:t}}). By substituting equation 6 and 9 into equation 8, the weight updating rule can be shown to be as illustrated in equation 10:

$${w}_{t}^{i , n} ∝ {w}_{t - 1}^{i , n} \frac{p ( {z}_{t}^{i} \vert {x}_{t}^{i , n} ) p ( {x}_{t}^{i , n} \vert {x}_{0 : t - 1}^{i , n} ) p ( {z}_{t}^{{J}_{t}} \vert {x}_{t}^{i , n} , {z}_{t}^{j} )}{q ( {x}_{t}^{i , n} \vert {x}_{0 : t - 1}^{i , n} , {z}_{1 : t}^{i} , {z}_{1 \text{:} t}^{{J}_{1 \text{:} t}} )} . \qquad ( 10 )$$

For most application purposes, only xₜⁿ, xₜ₋₁ⁿ, and xₜ₋₂ⁿ need to be stored and one can effectively disregard the path x_{0:t-3}ⁿ and the history of observations z_{1:t-1}. By this approach the modified weight becomes as shown in equation 11:

$${w}_{t}^{i , n} ∝ {w}_{t - 1}^{i , n} \frac{p ( {z}_{t}^{i} \vert {x}_{t}^{i , n} ) p ( {x}_{t}^{i , n} \vert {x}_{t - 1}^{i , n} , {x}_{0 : t - 2}^{i , n} ) p ( {z}_{t}^{{J}_{t}} \vert {x}_{t}^{i , n} , {z}_{t}^{j} )}{q ( {x}_{t}^{i , n} \vert {x}_{t - 1}^{i , n} , {z}_{t}^{i} , {z}_{1 t}^{{J}_{1 \text{:} t}} )} . \qquad ( 11 )$$

As mentioned above, it becomes useful to introduce a so-called repulsion force to resist excessive attraction among the interactive observations and magnetic field theory provides an analogy to facilitate the description of this force. Consider, for the purposes of example and explanation, a simple case where zₜ^{J}^{ₜ}={zₜ^{j}} were the two objects i and j are two magnetic monopoles having the same polarity. Since each object generates an observation while the corresponding magnet produces a magnetic field, the observations bear the analogy with the magnetic fields. Such assumptions are in face consistent with the earlier assumptions made with respect to the graphical model. That is, that different object's states (here, the magnets) at certain time are independent while they interact with each other only through their observations (here, the magnetic field).

In this analogy the local likelihood p(zₜⁱ|xₜⁱ) only characterizes the intensity of the corresponding local magnetic field while the interactive function p(zₜ^{J}^{ₜ}|xₜⁱ, zₜⁱ) represents the mutual repulsion between two magnetic fields. This constitutes a useful analogy to the concept of potential difference in magnetic theory that is related to the distance between two points in repulsive magnetic fields. In particular, when the distance is small the repulsion is strong and vice versa. Therefore, as a specific example, for each particle xₜ^{i,n} one can calculate a magnetic repulsion weight defined as shown in equation 12:

$${ϕ}_{t}^{i , n} \text{(} {z}_{t}^{{J}_{t}} , {z}_{t}^{i} \vert {x}_{t}^{i , n} ) = 1 - \frac{1}{{α}_{1}} exp \{ - \frac{{d}_{i , n , t}^{2}}{{σ}_{1}^{2}} \} \qquad ( 12 )$$

where α₁ is a normalization constant, σ₁ is a prior constant that characterizes the allowable maximal interaction distance, d_{i,n,t} is the distance between the current particle's observation and the interactive observation zₜ^{j}, for example, can be the Euclidean distance d_{i,n,t}=∥zₜ^{j}−zₜⁱ|xₜ^{i,n}∥. For some practical purposes it can be acceptable to use the reciprocal of the area of an object overlapping region to represent this distance for simplicity and also to set α₁=1 and σ₁=10/Aₒ˜50/Aₒ where Aₒ is the average area of objects (ellipses) in the initial frame. In such a case the interactive function can be approximately estimated as shown in equation 13:

$$p \text{(} {z}_{t}^{{J}_{t}} \vert {x}_{t}^{i} , {z}_{t}^{i} ) = {ϕ}_{t}^{i} ( \cdot ) \approx {\sum }_{n = 1}^{{N}_{x}} \frac{{ϕ}_{t}^{i , n}}{{\sum }_{{n}^{′} = 1}^{{N}_{x}} {ϕ}_{t}^{i , {n}^{′}}} δ ( {x}_{t}^{i} - {x}_{t}^{i , n} ) \qquad ( 13 )$$

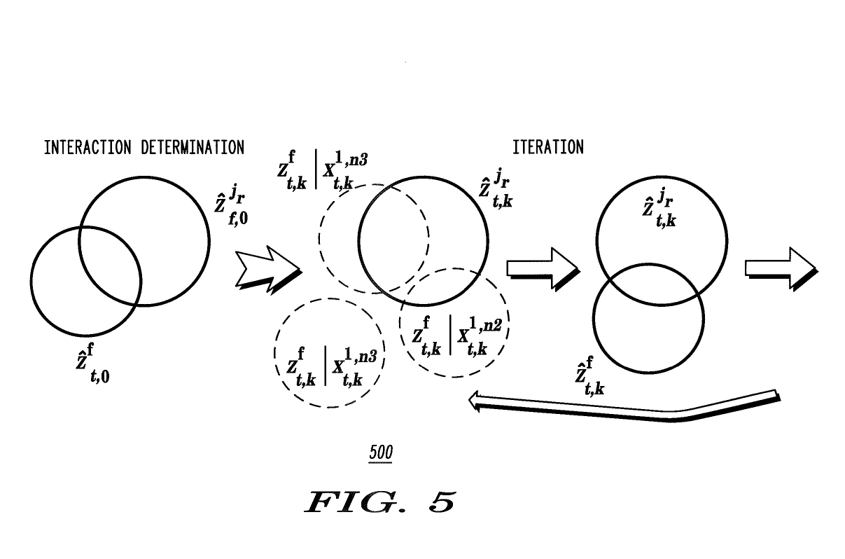

By one approach it can be useful to recursively locate the interactive observations and iterate the repulsion process to reach a relatively stable state. FIG. 5 illustrates one half on one repulsion iteration cycle 500. In this example the subscript k-1, . . . , K represents the iteration time. In the illustration the dashed ellipses represent the particles while the solid ellipses represent the temporary estimates of the object's observations. At the beginning of iterating at time t, one can first roughly estimate the observation's regions \hat{z}_{t,0}ⁱ and \hat{z}_{t,0}^{J}^{ₜ} using two independent trackers. When they have an overlapping area, one can determine that they are interacting and then trigger this recursive estimation. Subsequently, each particle's observation of object i, z_{t,k}ⁱ|x_{t,k}^{i,n} is repelled by the temporary estimate \hat{z}_{t,k}^{j} by calculating the here-styled magnetic repulsion weight. The weighted mean of all the particles can serve to specify the new temporary estimate of object i's observation \hat{z}_{t,k}ⁱ. Then, one can similarly calculate the here-style magnetic repulsion weight for object j's particles and thus estimate \hat{z}_{t,k}^{j,n} to complete one iteration cycle.

When zₜⁱ has two interactive observations zₜ^{J}^{ₜ}={zₜ^{J}^{₁}, zₜ^{J}^{₂}}, it should be repelled by the other two simultaneously. This, in turn, can lead to revising equation 12 to be:

$${ϕ}_{t}^{i , n} ( \cdot ) = ( 1 - \frac{1}{{α}_{11}} exp \{ - \frac{{d}_{i , {j}_{1} , n , t}^{2}}{{σ}_{11}^{2}} \} ) ( 1 - \frac{1}{{α}_{12}} exp \{ - \frac{{d}_{i , {j}_{2} , n , t}^{2}}{{σ}_{12}^{2}} \} ) \qquad ( 14 )$$

where α₁₁ and α₁₂ are normalization constants, σ₁₁ and σ₁₂ are again prior constants, d_{i,j1,n,t} and d_{i,j2,n,t} are the distances between the current particle's observation zₜⁱ|xₜ^{i,n} and other interactive observations z_{t,k}^{j1} and z_{t,k}^{j2}, respectively. For some application purposes it can be acceptable to set α₁₁=α₁₂=1 and choose σ₁₁ and σ₁₂ =10/Aₒ˜50/Aₒ where Aₒ is the average area of objects (ellipses) in the initial frame.

By leveraging this magnetic potential model, the interactive function p(zₜ^{J}^{ₜ}|xₜⁱ, zₜⁱ) reduces the probability that object estimates will occupy the same position in the feature space. In a sense, it may be helpful to regard this use of gravitational attraction versus magnetic repulsion as a competitive exclusion principle. By using the above-described magnetic potential model to estimate the interactive function, a given tracker can successfully separate the image observation in occlusion and thus solve the error merge problem. It is possible, however, for the mutual repulsion techniques described to lead to false object labeling (particularly following sever occlusion). If desired, then, these teachings may further accommodate use of a magnetic potential model to address this issue.

By one approach, an ad hoc 1^{st} order inertia Markov chain can serve to estimate the 2^{nd} order state transition density p(xₜⁱ|xₜ₋₁ⁱ, xₜ₋₂ⁱ) and solve the aforementioned object labeling problem with considerably reduced computational cost. This approach is exemplified in equation 15 as follows:

$$\begin{matrix}p \text{(} {x}_{t}^{i} \vert {x}_{t - 1}^{i} , {x}_{t - 2}^{i} ) = p \text{(} {x}_{t}^{i} \vert {x}_{t - 1}^{i} ) \frac{p ( {x}_{t - 2}^{i} \vert {x}_{t - 1}^{i} )}{p ( {x}_{t - 2}^{i} \vert {x}_{t - 1}^{i} )} \\ = p \text{(} {x}_{t}^{i} \vert {x}_{t - 1}^{i} ) {φ}_{t}^{i} ( {x}_{t}^{i} , {x}_{t - 1}^{i} , {x}_{t - 2}^{i} )\end{matrix} \qquad ( 15 )$$

where the state transition density p(xₜⁱ|xₜ₋₁ⁱ) can be modeled by a 1^{st} order Markov chain as usual in a typical Bayesian tracking method. This can be estimated by either a constant acceleration model or by a Gaussian random walk model. φₜⁱ (.) comprises an inertia function and relates with two posteriors.

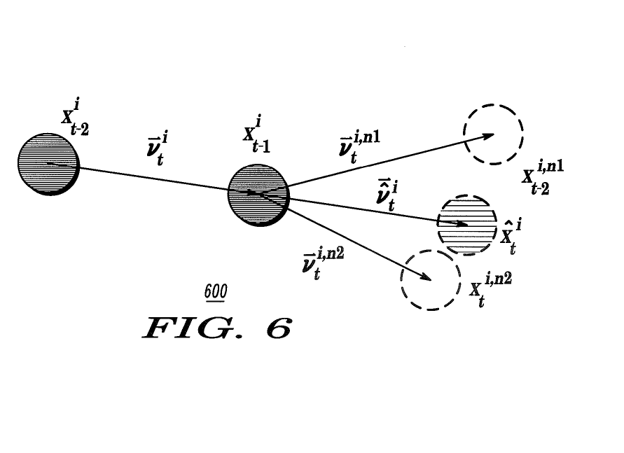

FIG. 6 illustrates a corresponding analysis 600 of object i's motion in three consecutive frames where shadow ellipses represent the states and dashed line ellipses represent the particles. The illustrated motion vector comprises a reference motion vector from xₜ₋₂ⁱ to xₜ₋₁ⁱ. By shifting the motion vector along its direction, one can establish the inertia state \hat{x}ₜⁱ and its inertia motion vector for the current frame. Even if there are external forces present, so long as the frame rate is sufficiently high one can assume that xₜⁱ is not too distant from \hat{x}ₜⁱ. Note also that xₜ^{i,n1}, xₜ^{i,n2} are particles of state xₜⁱ.

The inertia weights are defined as shown below in equation 16

$${φ}_{t}^{i , n} ( {x}_{t}^{i , n} , {x}_{t - 1}^{i} , {x}_{t - 2}^{i} ) ∝ \frac{1}{{α}_{2}} exp \{ - \frac{{( {θ}_{t , n}^{t} )}^{2}}{{σ}_{21}^{2}} \} \cdot exp \{ - \frac{{( ‖ {\vec{v}}_{t}^{i , n} ‖ - ‖ {\vec{\hat{v}}}_{t}^{i} ‖ )}^{2}}{{σ}_{22}^{2}} \} \qquad ( 16 )$$

where α₂ is a normalization term and σ₂₁ and σ₂₂ are prior constants that characterize the allowable variances of a motion vector's direction and speed respectively. In equation 16,

$${\vec{v}}_{t}^{i , n} = {x}_{t}^{i , n} - {x}_{t - 1}^{i} , {{v}^{\vec{\hat{}}}}_{t}^{i} = {x}_{t - 1}^{i} - {x}_{t - 2}^{i} ; {θ}_{t , n}^{i} = ∠ ( {\vec{v}}_{t}^{i , n} , {{v}^{\vec{\hat{}}}}_{t}^{i} )$$

is the angle between

$${\vec{v}}_{t}^{i , n} and {{v}^{\vec{\hat{}}}}_{t}^{i} .$$

### The norms

$$‖ {\vec{v}}_{t}^{i , n} ‖ and ‖ {{v}^{\vec{\hat{}}}}_{t}^{i} ‖$$

are the Euclidean metrics. Accordingly, the inertia function can be approximated as shown in equation 17 below:

$${φ}_{t}^{i} ( {x}_{t}^{i} , {x}_{t - 1}^{i} , {x}_{t - 2}^{i} ) \approx {\sum }_{n = 1}^{{N}_{i}} \frac{{φ}_{t}^{i , n}}{{\sum }_{{n}^{′} = 1}^{{N}_{i}} {φ}_{t}^{i , {n}^{′}}} δ ( {x}_{t}^{i} - {x}_{t}^{i , n} ) \qquad ( 17 )$$

The prior art has leveraged other image cues such as gradient, color, and motion in order to estimate a local observation likelihood. Here, if desired, one can combine existing color histogram models and a principle component analysis (PCA)-based model to efficiently estimate the local likelihood exemplified by equation 18:

p(zₜⁱ|xₜⁱ)=p_{c}·pₚ. (18)

where p_{c} and pₚ are the likelihood densities estimated by the color histogram and PCA models respectively.

For a color cue, one can use a Bhattacharyya distance to measure the similarity between a reference histogram hₒⁱ that is obtained prior to tracking and the histogram hₜ^{i,n} that is determined by particle xₜ^{i,n} for object i. Equation 19 exemplifies such an approach:

$${d}_{c} = \sqrt{1 - {\prod }_{b = 1}^{B} \sqrt{{h}_{0}^{i} ( b ) {h}_{t}^{i , n} ( b )}} . \qquad ( 19 )$$

where b is the index of bins. The color factor can then be specified by a Gaussian distribution with variance σ_{c} as illustrated in equation 20:

$${p}_{c} \text{(} {z}_{t}^{i} \vert {x}_{t}^{i , n} ) = \frac{1}{\sqrt{2 π} {σ}_{c}} exp \{ - \frac{{d}_{c}^{2}}{2 {σ}_{c}^{2}} \} . \qquad ( 20 )$$

In this example, the color space employed is simply the normalized YCbCr space with 8 bins for CbCr and only 4 bins coarsely provided for luminance.

To apply principle component analysis here, one may first collect a set of training examples of tracking objects. One may then use singular value decomposition to obtain the Karhune-Loeve basis vectors. To measure a likelihood of an image region determined by xₜ^{i,n}, one can calculate the Mahalanobis distance dₚ between the image region and the mean of the training examples. The PCA factor can be defined as a Gaussian distribution with variance σₚ as illustrated in equation 21:

$${p}_{p} \text{(} {z}_{t}^{i} \vert {x}_{t}^{i , n} ) = \frac{1}{\sqrt{2 π} {σ}_{p}} exp \{ - \frac{{d}_{p}^{2}}{2 {σ}_{p}^{2}} \} . \qquad ( 21 )$$

So configured, those skilled in the art will recognize and understand that these teachings comprise a distributed multiple objects tracking architecture that uses multiple interactive trackers and that extends traditional Bayesian tracking structures in a unique way. In particular, this approach eschews the joint state representation approach that tends, in turn, to require high complexity and considerable computational capabilities. Instead, a conditional density propagation mathematical structure is derived for each tracked object by modeling the interaction among the object's observations in a distributed scheme. By estimating the interactive function and the state transition density using a magnetic-inertia potential model in the particle filtering implementation, these teachings implicitly handle the error merge problems and further lead to resolution of object labeling problems as well. These teachings are sufficiently respectful of computational requirements to readily permit use in a real-time application setting.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
capturing temporally parsed data regarding at least a first and a second item;
automatically using, at least in part, disjoint probabilistic analysis of the temporally parsed data to disambiguate state information as pertains to the first item from information as pertains to the second item.

2. The method of claim 1 wherein automatically using, at least in part, probabilistic analysis of the temporally parsed data to disambiguate state information as pertains to the first item from information as pertains to the second item comprises using a joint probability as pertains to the temporally parsed data for the first item and the temporally parsed data for the second item.

3. The method of claim 2 wherein automatically using, at least in part, probabilistic analysis of the temporally parsed data comprises using, at least in part, a Bayesian-based probabilistic analysis of the temporally parsed data.

4. The method of claim 3 wherein using, at least in part, a Bayesian-based probabilistic analysis of the temporally parsed data comprises using:
a transitional probability as pertains to temporally parsed data for the first item as was captured at a first time and temporally parsed data for the first item as was captured at a second time that is different than the first time;
a transitional probability as pertains to temporally parsed data for the second item as was captured at the first time and temporally parsed data for the second item as was captured at the second time.

5. The method of claim 4 wherein:
using a transitional probability as pertains to temporally parsed data for the first item as was captured at a first time and temporally parsed data for the first item as was captured at a second time further comprises using a transitional probability as pertains to first state information for the first item as pertains to the first time and second state information for the first item as pertains to the second time;
using a transitional probability as pertains to temporally parsed data for the second item as was captured at the first time and temporally parsed data for the second item as was captured at the second time further comprises using a transitional probability as pertains to first state information for the second item as pertains to the first time and second state information for the second item as pertains to the second time.

6. The method of claim 5 wherein using, at least in part, a Bayesian-based probabilistic analysis of the temporally parsed data further comprises using:
a conditional probability as pertains to temporally parsed data for the first item and state information for the first item;
a conditional probability as pertains to temporally parsed data for the second item and state information for the second item.

7. The method of claim 1 wherein the first and second item each comprise an object.

8. The method of claim 1 wherein the first and second item each comprise a discernable energy wave.

9. The method of claim 1 wherein automatically using, at least in part, disjoint probabilistic analysis of the temporally parsed data to disambiguate state information as pertains to the first item from information as pertains to the second item comprises automatically using, at least in part, disjoint probabilistic analysis of the temporally parsed data to disambiguate state information as pertains to the first item from state information as pertains to the second item.

10. The method of claim 1 wherein capturing temporally parsed data regarding at least a first and a second item comprises capturing temporally parsed data regarding at least a first and a second item using only a single data capture device.

11. An apparatus comprising:
a memory having captured temporally parsed data regarding at least a first and a second item stored therein;
a processor operably coupled to the memory and being configured and arranged to automatically use, at least in part, disjoint probabilistic analysis of the temporally parsed data to disambiguate state information as pertains to the first item from information as pertains to the second item.

12. The apparatus of claim 11 wherein the processor is further configured and arranged to automatically use a joint probability as pertains to the temporally parsed data for the first item and the temporally parsed data for the second item.

13. The apparatus of claim 12 wherein the processor is further configured and arranged to automatically use, at least in part, a Bayesian-based probabilistic analysis of the temporally parsed data.

14. The apparatus of claim 13 wherein the Bayesian-based probabilistic analysis of the temporally parsed data comprises using:
a transitional probability as pertains to temporally parsed data for the first item as was captured at a first time and temporally parsed data for the first item as was captured at a second time that is different than the first time;
a transitional probability as pertains to temporally parsed data for the second item as was captured at the first time and temporally parsed data for the second item as was captured at the second time.

15. The apparatus of claim 14 wherein the processor is further configured and arranged to:
use a transitional probability as pertains to first state information for the first item as pertains to the first time and second state information for the first item as pertains to the second time;
use a transitional probability as pertains to first state information for the second item as pertains to the first time and second state information for the second item as pertains to the second time.

16. The apparatus of claim 15 wherein the processor is further configured and arranged, at least in part, to use the Bayesian-based probabilistic analysis of the temporally parsed data by using:
a conditional probability as pertains to temporally parsed data for the first item and state information for the first item;
a conditional probability as pertains to temporally parsed data for the second item and state information for the second item.

17. The apparatus of claim 11 wherein the first and second item each comprise an object.

18. The apparatus of claim 11 wherein the first and second item each comprise a discernable energy wave.

19. The apparatus of claim 11 wherein the processor is configured and arranged to automatically use, at least in part, disjoint probabilistic analysis of the temporally parsed data to disambiguate state information as pertains to the first item from information as pertains to the second item by automatically using, at least in part, disjoint probabilistic analysis of the temporally parsed data to disambiguate state information as pertains to the first item from state information as pertains to the second item.

20. The apparatus of claim 11 further comprising:
a single image capture device operably coupled to the memory such that the captured temporally parsed data is captured via the single image capture device.
